(19) United States
(12) Patent Application Publication
(10) Pub. No.: US 2026/0161154 A1
(43) Pub. Date: Jun. 11, 2026

(54) METHOD FOR CONFIGURING A CONTROL NETWORK, AND CONTROL NETWORK, COMPUTER PROGRAM AND COMPUTER-READABLE MEDIUM

(71) Applicant: Siemens Energy Global GmbH & Co. KG, Munich, Bayern (DE)

(72) Inventor: Andreas Drebinger, Herzogenaurach (DE)

(73) Assignee: Siemens Energy Global GmbH & Co. KG, Munich, Bayern (DE)

(21) Appl. No.: 18/727,082

(22) PCT Filed: Dec. 21, 2022
(86) PCT No.: PCT/EP2022/087317

§ 371 Date: Jul. 6, 2024

(30) Foreign Application Priority Data
Jan. 13, 2022 (EP) 22151388.0

(51) Int. Cl. G05B 19/418

(52) U.S. Cl. CPC G05B 19/41845; G05B 19/4183

(57) ABSTRACT

A method for configuring a control network, wherein the control network includes a higher-level central unit for controlling and monitoring a system assembly having a plurality of decentralised systems, and at least one lower-level remote unit for directly controlling a decentralised system, wherein, in order to control the decentralised system, projection data having system-related objects and/or modules are stored in the remote unit. A control network and a computer program and a computer-readable medium are provided for configuring a control network.

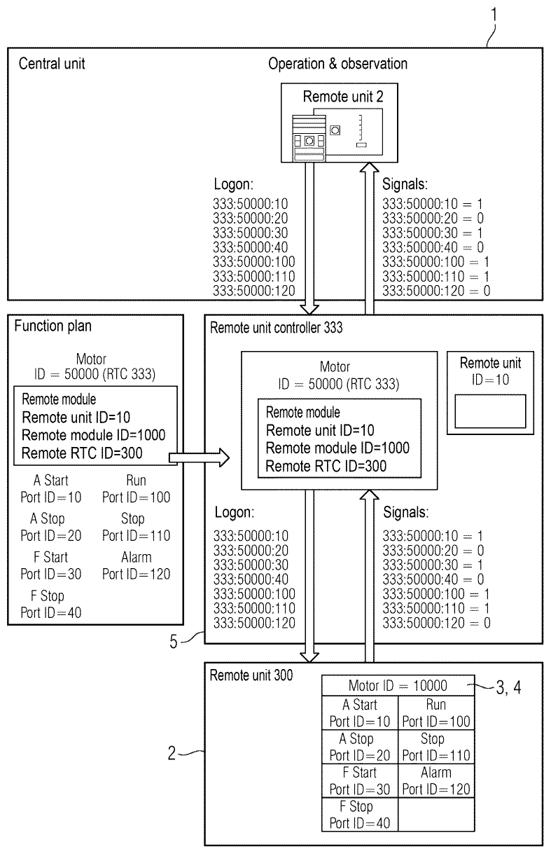

### CROSS REFERENCE TO RELATED APPLICATIONS

This application is the US National Stage of International Application No. PCT/EP2022/087317 filed 21 Dec. 2022, and claims the benefit thereof, which is incorporated by reference herein in its entirety. The International Application claims the benefit of European Application No. EP22151388 filed 13 Jan. 2022.

### FIELD OF INVENTION

The present invention relates to a method for configuring a control network. The present invention also relates to a control network and to a computer program and a computer-readable medium.

### BACKGROUND OF INVENTION

System arrangements which are distinguished by a multiplicity of decentralized systems coupled to one another are being increasingly used in many industrial sectors. In particular in connection with the switch to electricity generation using renewable and regenerative energies, there are large wind farms which comprise a multiplicity of wind power systems.

Against this background, there is often the need to be able to control the decentralized systems not only directly in situ but to also gain corresponding access from a central unit or central control station. In other words, in such cases, there is a control network comprising a superordinate central unit for controlling and monitoring a multiplicity of decentralized systems and subordinate remote units for directly controlling a decentralized system in each case. Such a control network may also be a SCADA (Supervisory Control and Data Acquisition) system. This is understood as meaning a computer system or the software for monitoring and controlling technical processes. Such control networks have fundamentally been tried and tested. However, it is sometimes considered to be disadvantageous that the configuration of such a control network is very complicated since all objects, modules and/or signals must be configured or planned separately in the central unit and in the remote unit. Such manual planning is also very susceptible to errors, which can result in inconsistent planning data in the central unit and in the remote unit. System images or other components, which refer to signals from the remote unit, must also be adapted so that they no longer reference the original module in the remote unit, but rather the signals provided via the communication protocol. This results in changes in the remote unit also requiring an adaptation both in the remote unit and in the central unit.

### SUMMARY OF INVENTION

An object of the present invention is therefore to provide a method for configuring a control network, which method avoids the aforementioned disadvantages and, in particular, makes it possible to easily configure a control network with few errors.

In a method for configuring a control network, wherein the control network comprises a superordinate central unit for controlling and monitoring a system arrangement with a plurality of decentralized systems and at least one subordinate remote unit for directly controlling a decentralized system, wherein, in order to control the decentralized system, planning data comprising system-related objects and/or modules are stored in the remote unit, this object is achieved by virtue of the fact that the method comprises the following steps of:
configuring at least one remote unit at the central unit by specifying information relating to the respective remote unit;
exporting the planning data from the remote unit(s) and importing the planning data into the central unit, wherein a unique identification code is assigned to all objects and modules of the remote unit(s) in the central unit by specifying the information relating to the respective remote unit.

The invention is therefore based on the fundamental consideration of specifying information relating to the respective remote unit at the central unit in a first step and in this way making the remote unit known to the central unit. In other words, the central unit learns of the existence of the respective remote unit through the specification of corresponding information.

In a second step, the planning data available in the remote unit are then exported and imported into the central unit. This means that all planning data from the remote unit are easily imported into the central unit in one step. In this manner, it is no longer necessary to manually input the planning data to both the remote unit and the central unit. Rather, it suffices to generate the planning data for controlling the decentralized system once in the remote unit and to then transmit them to the central unit. A unique global identification code can be assigned to each object and/or module relating to the respective remote unit in the central unit by specifying information relating to the remote unit in the central unit. This means that, even in the case of a multiplicity of decentralized systems which are intended to be monitored or controlled using the central unit, a unique global identification code is assigned to each object and each module of each remote unit, with the result that assignment errors can be reliably avoided. An object may be a signal, for example. Such a signal may be in the form of an analog and/or digital signal, for example. Furthermore, objects may also be ports. These may form part of a network address.

In a further configuration of the method according to the invention, the configuration of the remote unit at the central unit may comprise specifying a unique identifier of the remote unit and/or specifying a unique network address of the remote unit. However, the identifier of the remote unit is a unique identification for the corresponding remote unit in the central unit and is therefore an identification for a specific decentralized system. Network addresses, for example IP addresses, stipulate which access point can be used to make contact with the remote unit. It is also conceivable for further addresses to be able to be requested from the relevant remote unit, for example specific addresses of individual automation devices. If a plurality of redundant devices, for example servers, are provided in the remote unit, a plurality of network addresses may also be specified. It is also conceivable for the information relating to the respective remote unit to comprise further details, for example names, descriptions or access restrictions.

The identification code of the objects or modules in the central unit preferably contains an identifier of the respective remote unit. It is also conceivable for a remote unit controller to be interposed between the remote unit and the central unit, with the result that the identification code of the objects or modules in the central unit is indirectly referenced via the remote unit controller. In other words, such a remote unit controller acts as a gateway between the central unit and the respective remote unit. Accordingly, in this case, the identification code of the objects or modules in the central unit contains an identifier of the remote unit controller which then in turn establishes a connection to the respective remote unit.

In a further configuration, the decentralized system may comprise one or more automation component(s), wherein the system-related objects and/or modules are each assigned to an automation component and the identification code of the objects and modules in the central unit contains an identifier of the respective automation component of the decentralized system. In other words, a further hierarchical level may be provided if the decentralized system to be monitored or controlled comprises a plurality of components. Such automation components may be, for example, valves, motors, sensors or the like. If there are a plurality of such automation components in a decentralized system, the objects or modules can be assigned to these components. In this case, it makes sense for the identification code of the objects and modules in the central unit to contain an identifier of the respective automation component. This enables a simple and clear structure of the control network.

In a specific configuration, the identification code may comprise a plurality of alphanumeric, in particular numeric, character strings.

In a further configuration, a first character string may be the identifier of the respective remote unit or of a remote unit controller, a second character string may be the identifier of the respective automation component and a third character string may be the identifier of the respective object or module. In this case, the identification comprises three character strings which represent the hierarchy of the control network.

When importing the planning data into the central unit, the identifier of the respective automation component and/or the identifier of the respective object or module may be directly determined from the data to be imported because this is preferably identical to the respective identifier within the respective remote unit. Additional interventions by the user are not required in this case.

The planning data may comprise function plans and/or contact plans and/or signal plans and/or system images. Function plans indicate which objects are assigned to an automation component and their connection.

When importing the planning data, all signal references, even in system images, may be automatically converted from the identifiers originally allocated in the remote unit to the identifiers newly assigned in the central unit. This means that the identification of all objects is automatically converted during import into the central unit.

The method according to the invention may also be characterized in that the planning data are filtered and/or manually selected when being imported into the central unit, with the result that it is possible to access only specific objects and/or modules of the remote unit in the central unit. In other words, access of the central unit to objects or modules of the remote unit is restricted in this case, which may be necessary for certain system configurations. Such a situation is present, for example, when certain interventions are intended to take place only in the immediate environment of the decentralized system for safety reasons.

According to one development of the method according to the invention, provision may be made for the exporting of the planning data from the remote unit and the subsequent importing into the central unit to be carried out in an automated manner, in particular in a change-controlled manner. This means that, in the event of changes in the remote unit, these changes are automatically transmitted to the central unit and so the central unit is automatically always kept up-to-date.

The control network may also have at least one remote unit controller which is assigned to one or more remote units. In other words, this is a component which is interposed between the central unit and the remote unit and provides exactly the same interfaces as a corresponding automation component. In other words, the remote unit controller acts as a type of gateway to the original remote unit.

The remote unit controller may preferably distinguish between a module with an automation function and an object or module in the remote unit. Unnecessary communication between the central unit and the remote unit can be avoided by interposing a remote unit controller between the central unit and the remote unit. The interposition of the remote unit controller also does not require any adaptation of other components, in particular software adaptations, since the functions in the central unit are available in the same manner as the function within the remote unit.

In this case, one or more remote units can be assigned to a remote unit controller. By way of such a remote unit controller, a plurality of components of a central unit or a plurality of central units may also access the respective automation components of a remote unit. Access to the remote unit and the associated automation components that is transparent to all components of the control network is achieved thereby.

Specifically, the remote unit controller may be arranged on the central unit or on the remote unit or between the remote unit and the central unit.

In a further configuration, two remote unit controllers may be assigned to each remote unit, wherein one remote unit controller is preferably arranged on the central unit and the other remote unit controller is preferably arranged on the remote unit.

Provision may also be made for the remote unit controller to buffer the data transmission between the remote unit and the central unit if the connection between the remote unit and the central unit has been temporarily interrupted. Such a remote unit controller which buffers the data transmission between the remote unit and the central unit is preferably arranged on the remote unit. This makes it possible to continuously record or forward data even if a physical connection to the central unit has been interrupted.

The central unit and the remote units may be connected using a network connection, in particular in the form of a Virtual Private Network (VPN).

The object on which the invention is based is also achieved by means of a control network which is designed and configured to carry out the method according to the invention described above. The object on which the invention is based is also achieved by means of a computer program comprising program code means for carrying out the method according to the invention described above and by means of a computer-readable medium comprising instructions which, when executed on at least one computer, cause the at least one computer to carry out the steps of the method described above.

### BRIEF DESCRIPTION OF THE DRAWINGS

For the further configuration of the method according to the invention, reference is made to the subclaims and the following description of an exemplary embodiment with reference to the drawing, in which:

The FIGURE shows a schematic illustration of a control network.

### DETAILED DESCRIPTION OF INVENTION

The FIGURE shows the structure of a control network. The latter has a superordinate central unit 1 for controlling and monitoring a system arrangement with a plurality of decentralized systems. The control network also comprises a subordinate remote unit 2 for directly controlling a decentralized system.

In the present case, the remote unit 2 comprises an automation component 3, specifically a motor 4. In the remote unit 2, the motor 4 has an identifier as an automation component in the form of the numeric character string 10000. The planning data relating to the motor also comprise a function plan with a plurality of objects in the form of signals/ports which contain, for example, the signal/port identifiers (port ID) 100 for starting the motor, 110 for stopping the motor and 120 for an alarm. The remote unit in turn has the identifier 300.

A remote unit controller 5 is arranged between the central unit 1 and the remote unit 2. In the present case, this remote unit controller is assigned to the remote unit 300 and acts as a gateway between the central unit 1 and the remote unit 2. In the present case, the remote unit controller has the identifier 333. The planning data relating to the motor which is directly controlled by the remote unit 300 are stored in the remote unit controller 5. The individual signals or modules have a unique identification code comprising three numeric character strings. For example, the identification code for the module “start the motor” initially comprises the number sequence 300 for the corresponding remote unit 2. The identifier for the automation component 3, the motor 4 in the present case, which here consists of the number sequence (ID) 10000 then follows in a manner separated by a colon. The third identifier (100) relates to the direct signal or the direct port for starting the motor. In this manner, a unique identification code is stored in the remote unit controller.

A unique identification code for the various modules is likewise assigned in the central unit. Since the remote unit controller 5 with the identifier 333 is arranged between the remote unit 2 with the identifier 300 and the central unit 1, the corresponding signal for starting the motor has, as a first number sequence, the number 333, followed by the identifier of the motor (50000) and the specific signal/port identifier (100). In this manner, the module of the remote unit 2 is uniquely identified in the central unit 1.

Such a control network is configured such that, in a first step, the remote unit 2 is made known to the central unit 1. Information relating to the remote unit 2 is specified for this purpose. Specifically, this may be the identifier 300 or the identifier of the remote unit controller 333. Information may also further comprise network addresses.

In a next step, the planning data, inter alia in the present case the function plan relating to the motor 4 and the objects/modules relating to the motor 4, are exported from the remote unit and imported into the central unit 1. A unique identification code is assigned to all objects of the remote unit 2, specifically the automation component 3 in the present case, in the central unit 1 (for example 333:50000:100).

The remote unit controller 5 is also designed, in the event of changes in the function plans of the remote unit 2, to automatically transmit these changes in the planning data to the central unit 1. This means that the central unit 1 is always up-to-date.

The remote unit controller 5 is fundamentally able to distinguish between a module, the automation function of which is locally executed in the remote unit 2, and a module which must gain access from other components, for example the central unit. Unnecessary communication between the central unit 1 and the remote unit 2 can therefore be avoided by interposing the remote unit controller 5. The interposition of the remote unit controller 5 also does not require any adaptation of other components, in particular software adaptation, since the functions in the central unit 1 are available in the same manner as the functions within the remote unit 2.

As a result of the method according to the invention, there is no need for any additional planning of signals, objects, modules or communication protocols for coupling remote units in the central unit since all objects are provided with a unique identification code. The signals used are therefore always consistent. Further mechanisms, such as the acknowledgement of alarms, need not be subsequently integrated either via additional planning. Such mechanisms are visible both in the remote unit and in the central unit irrespective of whether they are performed in a decentralized or central manner.

Although the invention has been described and illustrated more specifically in detail by means of the preferred exemplary embodiment, the invention is not restricted by the disclosed examples and other variations can be derived therefrom by a person skilled in the art without departing from the scope of protection of the invention.

1. A method for configuring a control network, wherein the control network comprises at least one, superordinate central unit for controlling and monitoring a system arrangement with a plurality of decentralized systems and at least one subordinate remote unit for directly controlling a decentralized system, wherein, in order to control the decentralized system, planning data comprising system-related objects and/or modules are stored in the remote unit, the method comprising:
configuring at least one remote unit at the central unit by specifying information relating to the respective remote unit;
exporting the planning data from the remote unit(s) and importing the planning data into the central unit(s), wherein a unique identification code is assigned to all objects and modules of the remote unit(s) in the central unit(s) by specifying the information relating to the respective remote unit.

2. The method as claimed in claim 1,
wherein the configuration of the remote unit at the central unit comprises specifying a unique identifier of the remote unit and/or specifying a unique network address of the remote unit.

3. The method as claimed in claim 1,
wherein the identification code of the objects or modules contains an identifier of the respective remote unit.

4. The method as claimed in claim 3,
wherein the decentralized system comprises one or more automation component, wherein the system-related objects and/or modules are each assigned to an automation component and the identification code of the objects and modules in the central unit contains an identifier of the respective automation component of the system.

5. The method as claimed in claim 4,
wherein the identification code comprises a plurality of alphanumeric character strings.

6. The method as claimed in claim 5,
wherein a first character string is the identifier of the respective remote unit, a second character string is the identifier of the respective automation component and a third character string is the identifier of the respective object or module.

7. The method as claimed in claim 1,
wherein the planning data comprise function plans and/or contact plans and/or signal plans and/or system images, and/or in that the planning data are filtered and/or manually selected when being imported into the central unit, with a result that it is possible to access only specific objects and/or modules of the remote unit in the central unit, and/or in that the exporting of the planning data from the remote unit and the subsequent importing into the central unit are carried out in an automated manner, and/or in a change-controlled manner.

8. The method as claimed in claim 1,
wherein the control network also has at least one remote unit controller which is assigned to one or more objects or modules with associated function plans.

9. The method as claimed in claim 8,
wherein the remote unit controller is arranged on a central unit or on the remote unit or between the remote unit and the central unit.

10. The method as claimed in claim 8,
wherein two remote unit controllers are assigned to each remote unit.

11. The method as claimed in claim 8,
wherein a remote unit controller buffers data transmission between the remote unit and the central unit if a connection between the remote unit and the central unit has been temporarily interrupted.

12. The method as claimed in claim 1,
wherein the central unit and the remote units are connected using a network connection.

13. A control network,
which is designed and configured to carry out the method as claimed in claim 1.

14. A computer program stored on a non-transitory computer-readable medium, comprising:
program code for carrying out the method as claimed in claim 1.

15. A non-transitory computer-readable medium, comprising:
instructions stored thereon which, when executed on at least one computer, cause the at least one computer to carry out the steps of the method as claimed in claim 1.

16. The method as claimed in claim 1,
wherein the control network comprises precisely one superordinate central unit.

17. The method as claimed in claim 5,
wherein the identification code comprises numeric character strings.

18. The method as claimed in claim 10,
wherein one remote unit controller is arranged on the central unit and one remote unit controller is arranged on the remote unit.

19. The method as claimed in claim 12,
wherein the network connection is a Virtual Private Network (VPN).
